(19) United States
(12) Patent Application Publication
(10) Pub. No.: US 2009/0269167 A1
(43) Pub. Date: Oct. 29, 2009

(54) Bookbinding device, bookbinding system, bookbinding method, and computer program product

(75) Inventors: Junichi IIDA, Kanagawa (JP); Shingo Matsuhita, Tokyo (JP); Takeshi Sasaki, Tokyo (JP); Hiroki Okada, Kanagawa (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/385,435

(22) Filed: Apr. 8, 2009

(30) Foreign Application Priority Data
Apr. 24, 2008 (JP) 2008-113943

(51) Int. Cl. B42B 5/10

(52) U.S. Cl. 412/7; 412/42

(57) ABSTRACT

A current processing mode is judged. The current processing mode can be a first mode, in which both a punching process and a binding process are performed, and a second mode, in which only the punching process is performed. A paper unit spacing, which is an interval between a last sheet of paper in a preceding paper unit and a first sheet of paper in a subsequent paper unit, is set depending on the current processing mode. A paper unit spacing for the first mode is longer than a paper unit spacing for the second mode.

### CROSS-REFERENCE TO RELATED APPLICATIONS

The present application claims priority to and incorporates by reference the entire contents of Japanese priority document 2008-113943 filed in Japan on Apr. 24, 2008.

### BACKGROUND OF THE INVENTION

1. Field of the Invention

The present invention relates to a bookbinding device, a bookbinding system, a bookbinding method, and a computer program product.

2. Description of the Related Art

A paper processing system is known in the art in which a plurality of types of processing devices are linearly (serially) connected to an image forming device. Such processing devices include, for example, a binding device, a punching device, and a stapling device. In such a paper processing system, a sheet of paper, on which an image is formed at the image forming device, is subjected to, for example, binding at the binding device, punching at the punching device, and stapling at the stapling device. As a result, a sheet of paper or a stack of paper that has been processed as desired is created. The image forming device can be a printer, a copier, a facsimile machine, and a digital multifunction product including a combination of functions of these functions.

The binding can include a function for binding an edge section or a center of the paper, a function for performing a bookbinding process by pressing an edge of the paper onto a tape coated with adhesive, and a function for creating a ring-bound stack of paper. To create the ring-bound stack of paper, a plurality of holes is formed on a binding side of the stack of paper and the stack of paper is bound with a metal coil, plastic rings, and the like.

A ring that can be used in ring binding has been disclosed, for example, in Japanese Patent Application Laid-open No. 2007-030319. Japanese Patent Application Laid-open No. 2007-030319 discloses a technique to solves problems arising due to linear expansion of a plastic binder. Particularly, a single binder is formed by interposing a spine section between a plurality of ring sections that can be opened and closed. A through-hole is provided on the ring section in an area perpendicular to the spine section, allowing the binder to expand and contract in a longitudinal direction, to a certain extent. A positioning section that holds the ring sections at a prescribed ring pitch is provided on a binder holding component of a binding processor. As a result, even when the binder linearly expands due to temperature rise, the positioning section can correct changes in length. As a result of the correction, the ring pitch can match a ring-hole pitch of a sheet of paper. In this manner, problems regarding attachment caused by pitch misalignment can be solved.

A technology related to ring holes used in ring binding has been disclosed, for example, in Japanese Patent Application Laid-open No. 2002-128385. What is disclosed is a paper processing device including a hole-punching device that can selectively form a plurality of types of hole. The types of holes that can be formed are displayed for a user on a display unit and the user a desired type of hole from among the displayed type of holes.

A device that performs binding by inserting a ring into a punched hole has been disclosed, for example, in Japanese Patent Application Laid-open No. 2005-138549. What is disclosed is a binding process device that includes a punching mechanism and a binding mechanism. The punching mechanism punches a hole in a paper using a hole-puncher and a die and then the binding mechanism inserts a ring-shaped binder into the hole. A conveying mechanism conveys a paper to the punching mechanism and conveys the paper from the punching mechanism to the binding mechanism and from the binding mechanism to a paper tray to discharge the paper. A controlling unit controls the punching mechanism, the binding mechanism, and the conveying mechanism. The binding section includes a binder cartridge storing ring-shaped binders that are stacked front-to-back. The binding section sandwiches a ring-shaped binder in a foremost row within the binder cartridge from above and below and attaches the ring-shaped binder to the punched hole. The binding process device also includes a controlling section that performs the above-described binding process in cooperation with external devices, such as a printing device including a copier and a printer, an automatic paper transporting device, an original reading device, and a paper collator. A configuration in which the hole-punching process and the binding process are performed on paper discharged from the external devices is also disclosed.

The ring used in ring binding is described in Japanese Patent Application Laid-open No. 2007-030319. The punched hole into which the ring for binding the stack of paper is inserted is described in Japanese Patent Application Laid-open No. 2002-128385. The binding process device that punches the hole into which the ring for binding the stack of paper is inserted and binds the stack of paper with the ring is described in Japanese Patent Application Laid-open No. 2005-138549. A device providing a function for punching a hole and a function for ring binding such as this, commonly referred to as a ring binder, provides the two above-described functions. Therefore, a “bind mode” and a “punch mode” are often set. In the bind mode, holes are punched on a sheet of paper, and then binding is performed using a ring member. On the other hand, in the punch mode, only holes are punched on the sheet of paper, i.e., no binding is performed.

Processing time differs between the bind mode and the punch mode. Considerable time is required to process a stack of paper containing lot of sheets in the bind mode. Therefore, a paper unit spacing needs to be made longer in the case when the bind mode is set compared to the case when the bind mode is not set. The paper unit spacing is a space (time) between a preceding paper unit and subsequent paper unit. In other words, appropriate adjustment of the paper unit spacing needs to be made-in advance.

### SUMMARY OF THE INVENTION

It is an object of the present invention to at least partially solve the problems in the conventional technology.

According to an aspect of the present invention, there is provided a bookbinding device including a punching unit that performs a punching process on a sheet of paper or a stack of paper, the punching process including making a hole in the sheet of paper or the stack of paper; a binding unit that performs a binding process on the sheet of paper or a stack of paper, the binding process including inserting a ring member in the hole; and a changing unit that changes a paper unit spacing, which is an interval between a last sheet of paper in a preceding paper unit and a first sheet of paper in a subsequent paper unit, such that the paper unit spacing differs between a first mode, in which both the punching process and the binding process are performed, and a second mode, in which only the punching process is performed.

According to another aspect of the present invention, there is provided a bookbinding method including punching process including making a hole in a sheet of paper or a stack of paper; a binding process including inserting a ring member in the hole made at the punching process; and changing a paper unit spacing, which is an interval between a last sheet of paper in a preceding paper unit and a first sheet of paper in a subsequent paper unit, such that the paper unit spacing differs between a first mode, in which both the punching process and the binding process are performed, and a second mode, in which only the punching process is performed.

According to still another aspect of the present invention, there is provided a computer program product including a computer-readable recording medium and computer program code stored on the computer-readable recording medium which when executed on a computer causes the computer to execute on a bookbinding device that includes a punching unit that performs a punching process on a sheet of paper or a stack of paper, the punching process including making a hole in the sheet of paper or the stack of paper; and a binding unit that performs a binding process on the sheet of paper or a stack of paper, the binding process including inserting a ring member in the hole judging a current processing mode, the current processing mode being any one of a first mode, in which both the punching process and the binding process are performed, and a second mode, in which only the punching process is performed; and setting a paper unit spacing, which is an interval between a last sheet of paper in a preceding paper unit and a first sheet of paper in a subsequent paper unit, corresponding to the current processing mode, a paper unit spacing for the first mode being longer than a paper unit spacing for the second mode.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an overall configuration of a bookbinding system according to an embodiment of the present invention;

FIG. 2 is a functional block diagram of the bookbinding system depicted in FIG. 1;

FIG. 3 is a schematic diagram for explaining an example of an internal configuration of a ring binding device depicted in FIG. 1;

FIG. 4 is a schematic diagram of an example of contents displayed on a display unit depicted in FIG. 1;

FIG. 5 is a flowchart of an example of paper unit spacing changing process;

FIG. 6 is a flowchart of another example of the paper unit spacing changing process;

FIGS. 7A and 7B are schematic diagrams for explaining the concept of paper unit spacing and paper unit spacing distance;

FIG. 8 is a schematic diagram for explaining another example of internal configuration of the ring binding device depicted in FIG. 1; and

FIG. 9 is a schematic diagram for explaining still another example of internal configuration of the ring binding device depicted in FIG. 1.

### DETAILED DESCRIPTION OF THE PREFERRED EMBODIMENTS

Exemplary embodiments of the present invention are explained below with reference to the accompanying drawings.

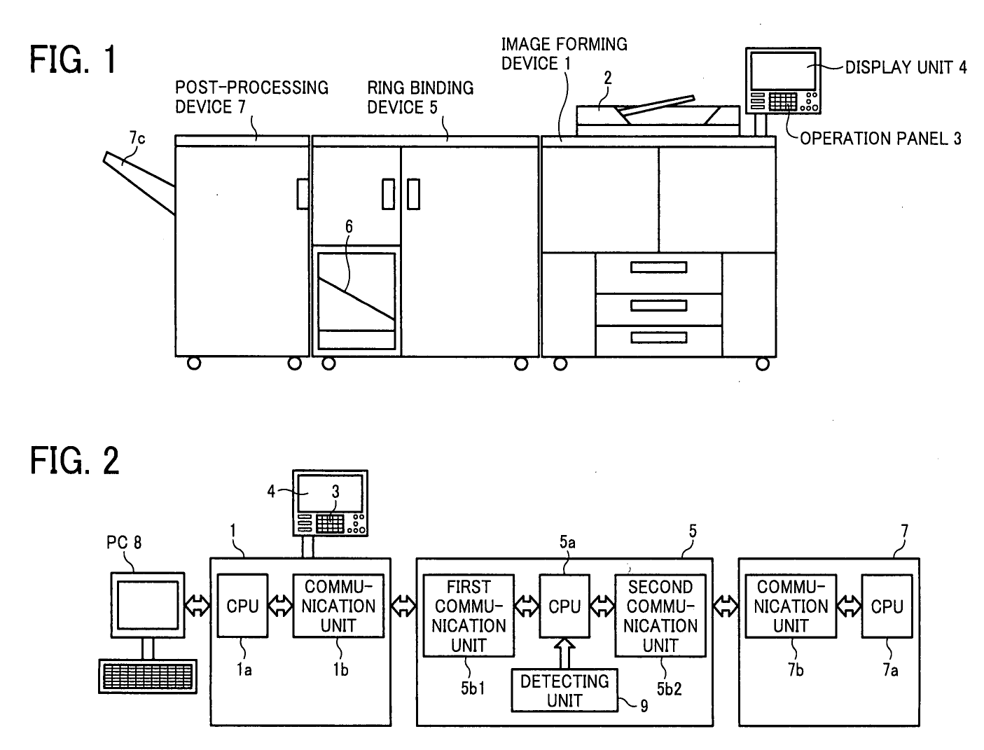

FIG. 1 is a schematic diagram of an overall configuration of a bookbinding system according to an embodiment of the present invention. The bookbinding system basically includes an image forming device 1, a ring binding device 5, and a post-processing device 7.

The image forming device 1 is a digital multifunction product (MFP) providing a copier function, a printer function, and a facsimile function. The image forming device 1 serves as a pre-processing device. The image forming device 1 includes an automatic document feeder (ADF) 2 and an operation panel 3. The ADF 2, provided on a top portion of the image forming device 1, conveys an original to an image reading unit of the image forming device 1. The operation panel 3 includes a display unit 4 that displays an inputting screen for various setting modes, various operation states, information regarding the various operations, and the like. The operation panel 3 serves as a user interface (I/F) for the image forming device 1, the ring binding device 5, and the post-processing device 7.

The ring binding device 5 is connected to the image forming device 1. The ring binding device 5 provides a function for receiving paper from the image forming device 1 and ring-binding the paper. A ring-binding paper discharging tray 6 onto which a booklet is discharged is provided within the ring binding device 5. The booklet is a stack of paper that has been ring-bound.

The post-processing device 7 is connected to the ring binding device 5. The post-processing device 7 performs post-processing such as stapling and paper alignment. A paper discharging tray 7c in which processed paper is discharged is provided in the post-processing device 7. Paper that has bypassed the ring binding device 5 is conveyed to the post-processing device 7. The ring binding device 5 and the post-processing device 7 can communicate with the image forming device 1. Various processes are performed by control command signals from the image forming device 1.

FIG. 2 is a functional block diagram of the bookbinding system. The image forming device 1 includes a central processing unit (CPU) 1a and a communication unit 1b. The ring binding device 5 includes a CPU 5a, a first communication unit 5b1, a second communication unit 5b2, and a detecting unit 9. The post-processing device 7 includes a CPU 7a and a communication unit 7b. Data is exchanged via the communication unit 1b, the first communication unit 5b1, the second communication unit 5b2, and the communication unit 7b. In the example illustrated in FIG. 2, the communication unit 1b is connected to the first communication unit 5b1 and the communication unit 7b is connected to the second communication unit 5b2. The image forming device 1 is connected to a personal computer (PC) 8 and functions as a printer.

The detecting unit 9 is a sensor that constantly monitors availability of a ring, a setting state of the ring, ring size, and the like.

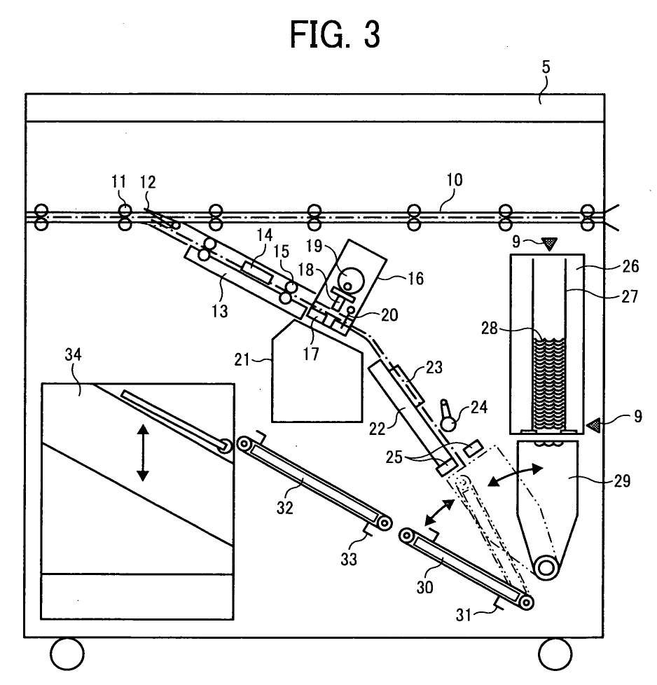

FIG. 3 is a schematic diagram for explaining an example of an internal configuration of the ring binding device 5. The ring binding device 5 is used online. A mechanism, operations, and functions of the ring binding device 5 will be successively described below.

The ring binding device 5 includes a horizontal conveying path 10, an aligning tray 13, an aligning tray 22, a stack conveying member 30, a final stack conveying member 32, and a stack tray 34. The ring binding device 5 also includes a clamp member 25 for holding a ring and a ring binding mechanism 29. A sheet of paper discharged from the image forming device 1 enters the horizontal conveying path 10 of the ring binding device 5. When the sheet of paper is not to be ring-bound, the sheet of paper is horizontally conveyed to the post-processing device 7, provided downstream. On the other hand, when the sheet of paper is to be ring-bound, a reversing roller 11 reverses the sheet of paper by a switch-back method. The reversing roller 11 is provided downstream on the horizontal conveying path 10. At this time, a switching claw 12 switches conveyance direction, and the sheet of paper is conveyed toward a punching section obliquely below the switching claw 12. The punching section includes a hole-punching unit 16.

In the punching section, on the way to the hole-punching unit 16, a jogger 14 on the aligning tray 13 jogs an edge section of the sheet of paper in a direction (referred to as a lateral direction) parallel to the conveyance direction. The jogger 14 comes into contact with the end section of the sheet of paper from a direction almost perpendicular to the conveyance direction. At the same time, a front edge of the sheet of paper in the conveyance direction comes into contact with a front edge stopper 20 of the aligning tray 13. The front edge stopper 20 projects onto the conveying path. The front edge of the sheet of paper in the conveyance direction is positioned by the front edge stopper 20. In other words, positions of the sheet of paper in the lateral direction and the conveyance direction (longitudinal direction) are decided by the aligning tray 13 and the front edge stopper 20. When the sheet of paper comes into contact with the front edge stopper 20, conveyance force is applied to the sheet of paper by a conveying roller 15 that includes a torque limiter. Therefore, damage to the front edge of the paper is prevented.

When the sheet of paper is positioned in this manner, an internal cam 19 of the hole-punching unit 16 rotates and pushes a hole puncher 18 downwards. As a result, a hole is punched in the sheet of paper, between the hole puncher 18 and a die 17. The hole-punching unit 16 has a multi-hole punching structure for ring binding. After holes are punched, the front edge stopper 20 retracts from the conveyance path, thereby releasing the sheet of paper from contact. The sheet of paper is then conveyed downstream to the aligning tray 22. Chad created when the holes are punched are stored in a punch chad hopper 21.

The aligning tray 22 receives all the sheets of paper that are to be formed into the booklet, one sheet at a time. The sheets of paper are stacked while being aligned. The aligning tray 22 includes a lateral alignment jogger 23, a striking roller 24, and the like. The striking roller 24 presses the sheets of paper in the conveyance direction of the sheets of paper. A fence (not shown) aligns the sheets of paper in the conveyance direction. The jogger 23 aligns the sheets of paper in the lateral direction. After all the sheets of paper are stacked and aligned on the aligning tray 22, the clamp member 25 holds the stack of paper near a binding side and applies pressure.

A ring cartridge 27 is stored in a ring cartridge holding unit 26 provided on a side of the aligning tray 22. Rings 28 are stacked within the ring cartridge 27. A type of plastic ring of which a circumference is divided into three is used; however, some other rings can be used. The plastic ring is a known plastic ring that is a same type as that described, for example, in Japanese Patent Application Laid-open No. 2007-030319. Various pieces of ring information of the rings 28 in the ring cartridge 27 are detected by the detecting unit 9, provided in a suitable area.

After all the sheets of paper are stacked and aligned on the aligning tray 22, the ring binding mechanism 29 rotates to a bottom portion of the ring cartridge 27 and retrieves a ring. The ring binding mechanism 29 takes a single ring from the ring cartridge 27. While holding the ring, the ring binding mechanism 29 rotates to a position under the clamp member 25. The ring binding mechanism 29 then inserts the ring into the punched (ring) hole punched on a lower edge of the stack of paper. Subsequently, a binding mechanism (not shown) performs ring binding. After the rotatable stack conveying member 30 moves to a position under the clamp member 25, the clamp member 25 is released. The ring-bound booklet is received by a discharging claw 31 provided on a belt of the stack conveying member 30. As a result, the booklet is transferred onto the stack conveying member 30.

The stack conveying member 30 then rotates in a counter-clockwise direction and moves to a position on roughly a same straight line as the final stack conveying member 32. The discharging claw 31 provided on the belt of the stack conveying member 30 passes the booklet to the final stack conveying member 32. A discharging claw 33 provided on a belt of the final stack conveying member 32 conveys the booklet from the final stack conveying member 32. The booklet is then discharged onto the stack tray 34 provided within the ring binding device 5.

When the punch mode is set, after the hole-punching unit 16 punches the holes, the sheets of paper are stacked and aligned on the aligning tray 22. Clamping operation by the clamp member 25 is omitted. After the rotatable stack conveying member 30 moves to the position under the clamp member 25, the clamp member 25 is released. The stack of paper is received by the discharging claw 31 provided on the belt of the stack conveying member 30, and transferred onto the stack conveying member 30. The stack conveying member 30 then rotates in the counter-clockwise direction. The discharging claw 31 provided on the belt of the stack conveying member 30 passes the stack of paper to the final stack conveying member 32. In the final stack conveying member 32, the discharging claw 33 conveys the stack of paper. The stack of paper is then discharged onto the stack tray 34.

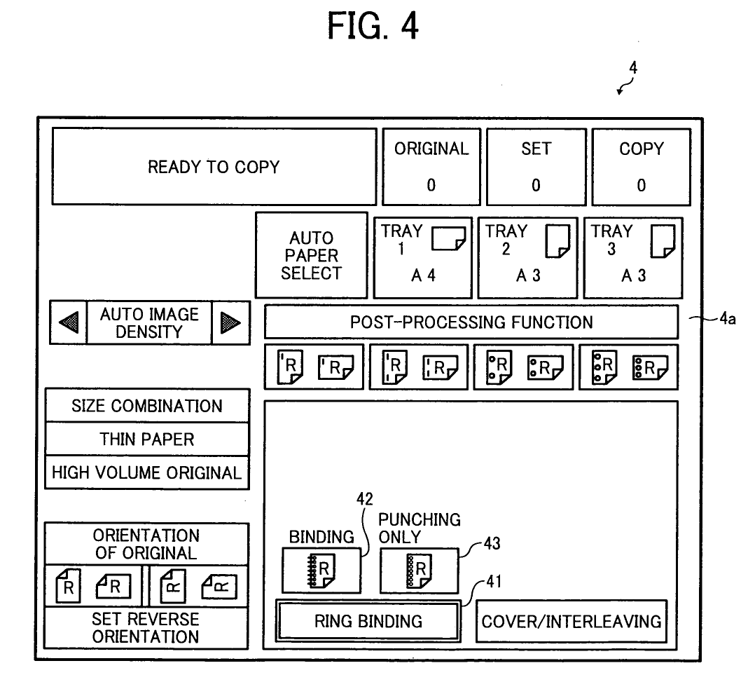

FIG. 4 is a schematic diagram of an example of contents displayed on the display unit 4. The display unit 4 displays, in addition to a “Ready to copy” display, keys related to a copy function, keys related to post-processing functions, keys related to toner concentration adjustment, keys related to original type, keys related to original setting direction, and the like. The keys related to the copy function include a “manuscript” key, a “set” key, a “copy” key, an “automatic paper selection” key, and the like. Soft keys are also displayed on an operation screen 4a. Here, when a “ring binding” key 41 displayed on the operation screen 4a is selected (a thick border indicates selection), an online “binding” key 42 and a “punching only” key 43 are displayed on the operation screen 4a.

A paper unit spacing is set to a predetermined value when a user selects the “binding” key 42 and a paper unit spacing is set to another predetermined value when a user selects when the user selects the “punching only” key 43. When a start key is pressed, or when paper-feeding starts, paper-feeding is controlled such that the set paper unit spacing is achieved. Particularly, the paper unit spacing is set longer in the bind mode than in the punch mode.

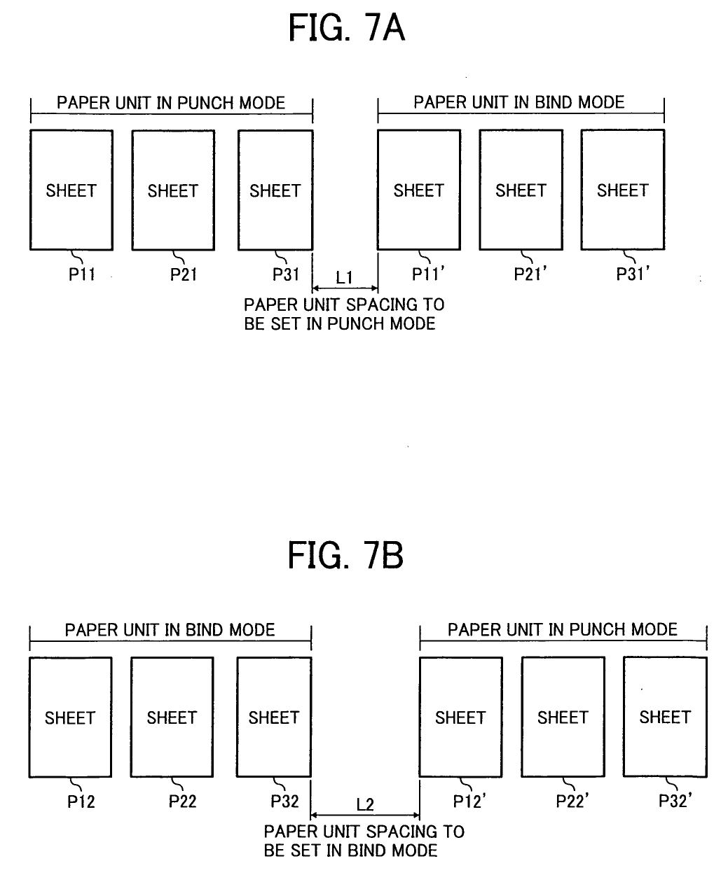

In other words, as shown in FIG. 7A, in a paper unit in the punch mode, first to third sheets of paper are perforated one sheet at a time. The first to third sheets of paper are then sequentially conveyed. The first to third sheets of paper sequentially stacked, thereby forming a single paper unit. Even when a sheet of paper to be conveyed next is in the bind mode (the bind mode includes two processes: punching a hole (punching process), and performing binding using rings (ring binding process)), when a preceding paper unit is in the punch mode, after the paper unit is stacked, the paper unit is discharged in the stacked state because other processes (performing binding using rings) are not particularly required to be performed. Therefore, even when three sheets of paper P11′, P21′, and P31′ of a following paper unit are in the bind mode, conveyance timing of a leading sheet of paper P11′ is, in addition to an ordinary paper spacing between sheets of paper, a paper spacing corresponding to an amount of time required to perform a discharging process of the previous paper unit.

On the other hand, as shown in FIG. 7B, when processing is performed in the punch mode after processing is performed in the bind mode, in the bind mode, three sheets of paper P12, P22, and P32 forming a paper unit are perforated one sheet at a time. When the three sheets of paper are stacked, the ring binding process is performed. As a result, the three sheets of paper are bound. Therefore, when a leading sheet of paper P12′ of three sheets of paper P12′, P22′, and P32′ of a following paper unit is conveyed at a same timing as a leading sheet of paper following a paper unit in the punch mode, the leading sheet of paper P12′ is conveyed to the aligning tray 22 before the ring-binding process on the preceding paper unit is completed. A collision occurs with the sheets of paper in the preceding paper unit.

Therefore, a paper unit spacing L2 is set such that the leading sheet of paper P12′ is conveyed to the aligning tray 22 after a last sheet of paper P32 of the paper unit in the bind mode is conveyed, the ring binding process is completed, and the bound unit is discharged. A distance L2 of the paper unit spacing is naturally longer than the paper unit spacing L1. A distance of paper unit spacing in the image forming device 1 is changed under an assumption that the distance L2 is longer than the paper unit spacing L1. In FIG. 7B, the following paper unit is in the punch mode. However, the following paper unit can be in the bind mode. When the following paper unit is in the bind mode, the paper unit spacing L2 can be set to be the same as that for the following paper unit. That is, the paper unit spacing need not be changed. Thus, the paper unit spacing is set depending on the processing mode of the preceding paper unit.

Regarding the paper unit spacing or the distance of the paper unit spacing (conveyance timing in terms of control), each of the following elements act as variation elements in distance setting of the paper unit spacing. The elements include a number of remaining rings of in the ring cartridge 27, an amount of remaining punching chad, paper size, ring diameter size, number of sheets of paper to be bound (number of sheets in a paper unit), and the like. Therefore, the paper unit spacing can be set based on each element. To lengthen the paper unit spacing (paper unit interval), following methods could be used:

(1) change paper feed timing of the sheet of paper to be fed (see Step S202 described below);

(2) provide a buffer member on the conveying path and change paper feed timing of the sheet of paper starting from the buffer member (see Step S208 described below);

(3) evacuate the sheet of paper to the buffer member, stack a plurality of sheets of paper, and subsequently feed the stacked sheets of paper (see Step S212 described below);

(4) lead the sheet of paper to a different conveying path and delay conveyance timing (see Step S205 described below); and

(5) change conveyance speed by accelerating and decelerating the conveyance of the sheet of paper being fed before the sheet of paper reach the hole-punching unit 16 within the ring binding device 5 (see Step S211 described below).

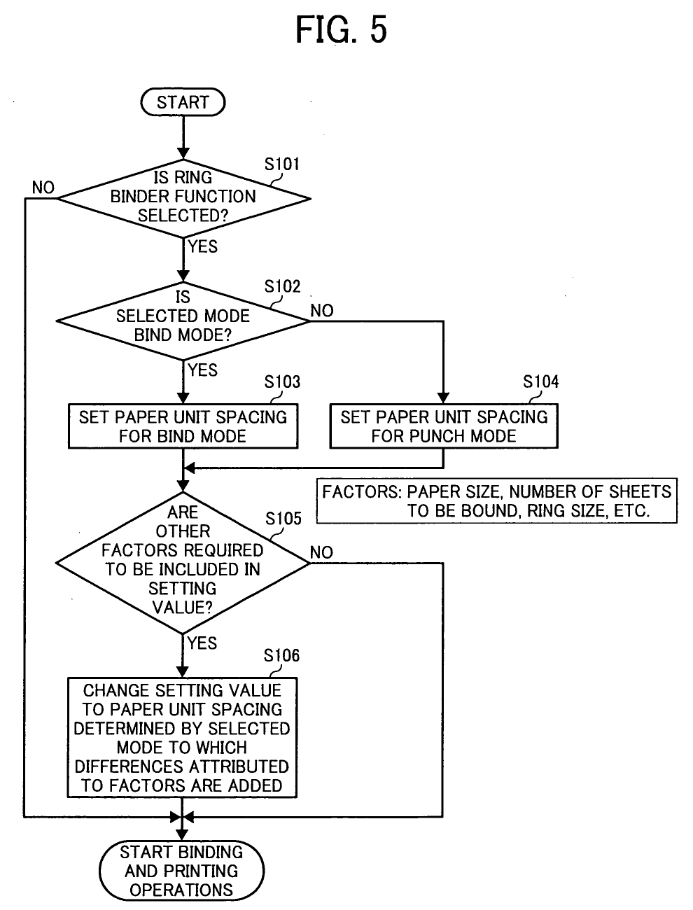

FIG. 5 is a flowchart of a paper unit spacing changing process performed by the CPU 1a of the image forming device 1. The CPU 1a reads a program code stored in a not shown read-only memory (ROM). The CPU 1a performs a process defined by the program code using a not shown random-access memory (RAM) as a work area. The CPU 5a of the ring binding device 5 and the CPU 7a of the post-processing device 7 operate in a similar manner.

When the paper unit spacing changing process is started, first, the CPU 1a checks whether the user selects the ring binder function (Step S101). The user can select the ring binder function by operating the “ring binding” key 41 on the operation screen 4a. When the ring binder function is selected, the CPU 1a further checks whether the user selects the bind mode (Step S202). The user can select the bind mode by operating the “binding” key 42 on the operation screen 4a. Alternatively, it is decided that the user has selected the punch mode when the user operates that the “punching only” key 43.

When the “binding” key 42 is selected at Step S102, the CPU 1a judges that the bind mode is selected. At Step S103, the CPU 1a sets the paper unit spacing L2 for the bind mode and proceeds to Step S105. When the user selects the “punching only” key 43, the CPU 1a judges that the punch mode is selected (i.e., bind mode is not selected). At Step S104, the CPU 1a sets the paper unit spacing for the punch mode, i.e., L1, and proceeds to Step S105.

At Step S105, the CPU 1a judges whether other factors are required to be considered to set a setting value of the paper unit spacing L1 or a setting value of the paper unit spacing L2. Other factors refer to the above-described elements, such as the paper size, the number of sheets of paper to be bound, and the ring diameter size. The CPU 1a judges, at Step S105, whether to consider the variation elements in the setting of the paper unit spacing. When the variation elements are required to be considered, the CPU 1a changes the setting to a distance obtained by differences attributed to the factors being added to the distance of the paper unit spacing L1 or the paper unit spacing L2 decided at Step S106 based on the selected mode. The CPU 1a then starts forming images for binding. When the variation elements are not required to be considered, the CPU 1a maintains the paper unit spacing set at Step S103 or Step S104. The CPU 1a then starts forming images for binding.

The above-described procedure can be set to be performed on the ring binding device 5 side. The ring binding device 5 can perform similar control operations in adherence to commands from the image forming device 1.

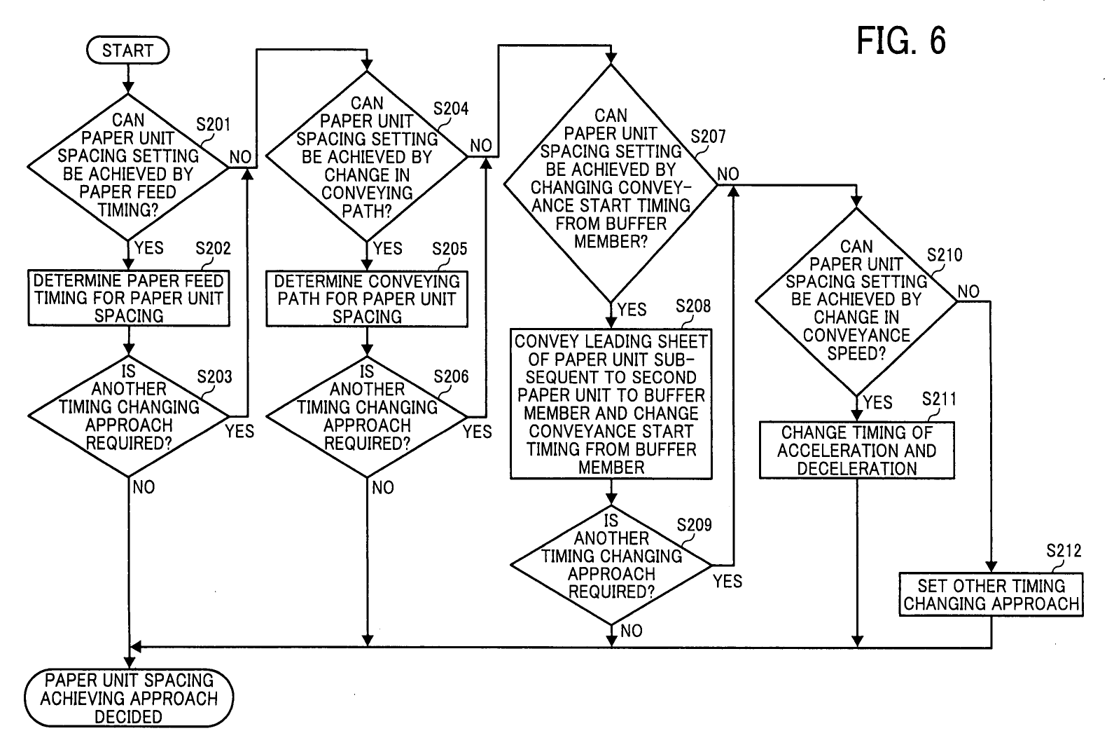

FIG. 6 is a flowchart of procedures performed when the CPU 1a sets the paper unit spacing at Step S103 or Step S104, and when the CPU 1a judges that the factors are to be included at Step S105.

When a process starts, first, at Step S201, to set the distance L1 or the distance L2 of the paper unit spacing, the CPU 1a judges whether the setting can be made with only a change in paper feed timing. When the CPU 1a judges that the setting can be made, the CPU 1a determines a paper feed timing for the paper unit spacing at Step S202. The CPU 1a judges at Step S203 whether another approach for changing the timing is required.

When another approach is not required (NO at Step S203), the CPU 1a sets the paper unit spacing by changing only the paper feed timing.

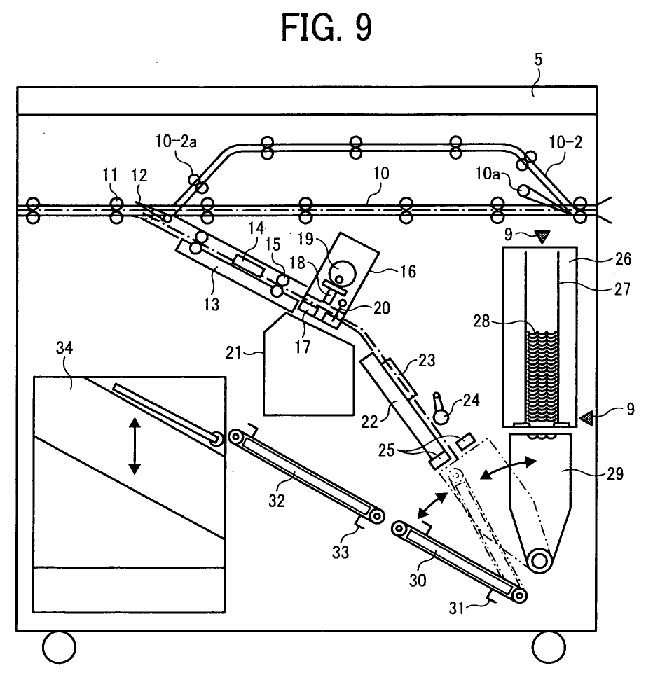

When the CPU 1a judges at Step S201 that the setting cannot be made, or when the CPU 1a judges at Step S203 that another approach is required, at Step S204, the CPU 1a checks whether the paper unit spacing (distance) can be changed by a change in the conveying path. As shown in FIG. 9, in the ring binding device 5, a second conveying path 10-2 having a longer conveyance distance is provided in addition to the ordinary horizontal conveying path 10. The change in the conveying path herein refers to conveying the sheet of paper over the second conveying path 10-2. When the paper unit spacing can be changed from L1 to L2 as a result of the sheet of paper being conveyed over the second conveying path 10-2, the CPU 1a judges that the paper unit spacing can be changed. The CPU 1a changes the conveying path at Step S205. When the second conveying path 10-2 is selected as the conveying path as a result of a branching claw 10a being operated, the sheet of paper is conveyed by a plurality of conveying rollers 10-2a. The paper unit spacing can be increased by an amount equivalent to an extension in conveying path length.

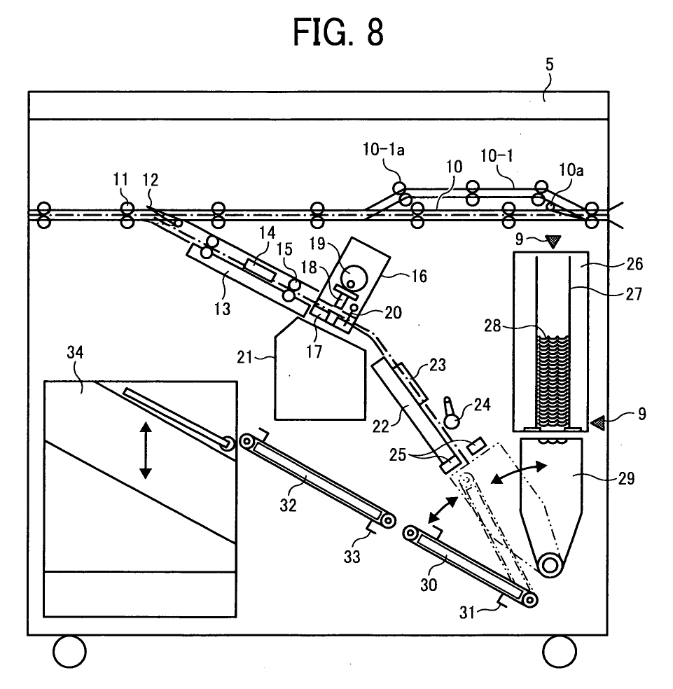

When the CPU 1a judges at Step S206 that another approach is not required, the CPU 1a sets the distance of the paper unit spacing using the conveying path decided at Step S205. When the CPU 1a judges that the timing cannot be changed by only the change in the conveying path, regardless of the decision at Step S205, or when the CPU 1a judges at Step S204 that the paper unit spacing cannot be set by only the change in the conveying path, the CPU 1a judges, at Step S207, whether the paper unit spacing L1 or the paper unit spacing L2 can be set by changing the paper feed timing of the sheet of paper starting from a buffer member 10-1. As shown in FIG. 8, in the ring binding device 5, the buffer member 10-1 that branches from the horizontal conveying path 10 is provided.

When the CPU 1a judges at Step S207 that the paper unit spacing can be set or requirements regarding the paper unit spacing can be achieved, at Step S208, the CPU 1a conveys a leading sheet of paper of a paper unit subsequent to a second paper unit over the buffer member 10-1 by operating the branching claw 10a, and changes a conveyance start timing of the leading sheet of paper from the buffer member 10-1. A start of conveyance of the leading sheet of paper is synchronized with a start of rotation of conveying rollers 10-1a of the buffer member 10-1. Next, at Step S209, the CPU 1a again checks whether another timing changing means is required. When another approach is necessary to perform timing changing, the CPU 1a sets the paper unit spacing by conveying the leading sheet of paper at the timing decided at Step S208.

When the CPU 1a judges at Step S209 that another approach is required, and when the CPU1a judges at Step S207 that the paper unit spacing cannot be set by the change in the conveyance start timing from the buffer member 10-1, at Step S210, the CPU 1a judges whether the paper unit spacing can be changed by a change in the conveyance speed. To change the conveyance speed, following processes and the like can be performed, and the paper unit spacing can be adjusted (paper unit interval is widened). The processes include:

(1) accelerating the conveyance speed of the last sheet of a preceding paper unit and decelerate the conveyance speed of a leading sheet of a following paper unit;

(2) accelerating the conveyance speed of only the last sheet of the preceding paper unit; and

(3) decelerating the conveyance speed of only the leading sheet of the following paper unit.

The speed is changed on the conveying path from when the sheet of paper is conveyed to the ring binding device 5 from the image forming device 1 until the sheet of paper is perforated by the hole-punching unit 16.

When the CPU 1a judges at Step S210 that the paper unit spacing can be changed by the change in the conveyance speed, the CPU 1a changes an acceleration and deceleration timing at Step S211. The timing can be set by each of the processes (1) to (3), described above.

On the other hand, when the CPU 1a judges that the paper unit spacing cannot be changed to a predetermined distance even when the conveyance speed is changed at Step S210, the CPU 1a employs another approach for changing the paper unit spacing that has not been described above. For example, such approach can include, in addition to the leading sheet of paper of the following unit, stacking an arbitrary number of sheets of paper following the leading sheet of paper in the buffer member 10-1, and conveying those sheets of paper when a desired paper unit spacing is achieved. Alternatively, an amount of time that the sheet of paper stops at a position of the stopper 20 that is in contact with the front edge of the sheet of paper can be adjusted. A condition under which the sheets of paper are stacked is that the number of sheets of paper is that allowing perforation by the hole-punching unit 16.

An operation in the punch mode may be continuously performed after an operation in the bind mode. At this time, the paper unit spacing is determined by the process performed on the preceding paper unit. In other words, when the operation in the punch mode is continuously performed after the operation in the bind mode, the paper unit spacing is that for the bind mode.

According to the embodiment, an example is described in which setting of the mode is performed by the display unit 4 of the operation panel 3 on the image forming device 1. However, when the image forming device 1 is connected to the personal computer 8 and functions as a printer, as shown in FIG. 1, the punch mode or the bind mode can be selected when printing instructions are entered in the personal computer 8. Printing and binding can be performed online. These functions are set in a printer driver of the personal computer 8. The image forming device 1 issues commands to the ring binding device 5 based on instructions from the printer driver. As a result, control related to the above-described paper unit spacing interval can be performed by the ring binding device 5.

As described above, according to the embodiment, the following effects and the like can be achieved:

(1) When the ring binder function is used, the ring binding device itself sets the paper unit spacing suited for the selected mode. Therefore, processing can be performed with high efficiency in the mode selected by the user, without the user having to worry about the paper unit spacing. As a result, a bookbinding device and a bookbinding system having excellent operability, controllability, and usability can be provided.

(2) The paper unit spacing is set to different values in the bind mode and in the punch mode. Therefore, manufacturability can be improved and usability can be enhanced when the bind mode and the punch mode are used in combination.

(3) The paper unit spacing is changed such that the paper unit spacing for the bind mode is longer than the paper unit spacing for the punch mode. That is, the paper unit spacing is narrowed in the punch mode. As a result, processing can be efficiently performed.

(4) The paper unit spacing that is changed to be longer in the bind mode is a length corresponding to the amount of time required for the ring binding process or longer. Therefore, the leading sheet of paper of the following paper unit is conveyed to the aligning tray after ring binding is completed. As a result, paper does not become jammed.

(5) Processing mode can be selected by the operation panel on the image forming device side. Therefore, a user-friendly system can be configured.

(6) Processing mode can be specified to the image forming device or the ring binding device from a computer. Therefore, a user-friendly system can be configured.

(7) A computer automatically sets the paper unit spacing in adherence to the processing mode. Therefore, the user is not required to set the paper unit spacing. As a result, processing can be efficiently performed.

Thus, an interval of a paper unit spacing is set in adherence to the processing mode, which improves manufacturability and enhances usability when two modes are used in combination.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A bookbinding device comprising:
a punching unit that performs a punching process on a sheet of paper or a stack of paper, the punching process including making a hole in the sheet of paper or the stack of paper;
a binding unit that performs a binding process on the sheet of paper or a stack of paper, the binding process including inserting a ring member in the hole; and
a changing unit that changes a paper unit spacing, which is an interval between a last sheet of paper in a preceding paper unit and a first sheet of paper in a subsequent paper unit, such that the paper unit spacing differs between a first mode, in which both the punching process and the binding process are performed, and a second mode, in which only the punching process is performed.

2. The bookbinding device according to claim 1, wherein the changing unit sets a first paper unit spacing for the first mode and sets a second paper unit spacing for the second mode, the first paper unit spacing being longer than the second paper unit spacing.

3. The bookbinding device according to claim 2, wherein the first paper unit spacing has a length corresponding to an amount of processing time required to perform the binding process in the first mode or longer.

4. The bookbinding device according to claim 2, wherein the changing unit changes time interval between the last sheet of paper in the preceding paper unit and the first sheet of paper in the subsequent paper unit.

5. The bookbinding device according to claim 2, wherein the changing unit changes a conveyance speed of at least one of the last sheet of paper in the preceding paper unit and the first sheet of paper in the subsequent paper unit.

6. The bookbinding device according to claim 5, wherein the changing unit increases a linear speed of the last sheet of paper in the preceding paper unit.

7. The bookbinding device according to claim 5, wherein the changing unit decreases a linear speed of the first sheet of paper in the subsequent paper unit.

8. The bookbinding device according to claim 2, further comprising a shorter conveying path and a longer conveying path, wherein the changing unit changes the paper unit spacing by selecting the longer conveying path for conveying the sheet of paper or the stack of paper.

9. The bookbinding device according to claim 2, further comprising a bypass conveying path, wherein the changing unit changes a conveyance timing from the bypass conveying path.

10. The bookbinding device according to claim 9, wherein a plurality of sheets of paper are evacuated to the bypass conveying path.

11. The bookbinding device according to claim 1, wherein the changing unit changes the paper unit spacing based on a mode of the preceding paper unit.

12. An image forming system comprising:
an image forming device that forms an image on a sheet of paper; and
a bookbinding device according to the claim 1 that receives the sheet of paper with an image formed thereon and performs the punching process or the binding process on the sheet of paper.

13. The image forming device according to claim 12, wherein
the image forming device and the bookbinding device each include a central processing unit and communication ports allowing intercommunication, and
the image forming device specifies to the binding device whether a processing mode is the first mode or the second mode.

14. The image forming system according to claim 13, wherein the image forming device includes a setting unit for setting the processing mode.

15. The image forming system according to claim 13, further comprising a computer, and
the computer specifies the processing mode to the image forming device or the bookbinding device via a printer driver.

16. A bookbinding method comprising:
punching process including making a hole in a sheet of paper or a stack of paper;
a binding process including inserting a ring member in the hole made at the punching process; and
changing a paper unit spacing, which is an interval between a last sheet of paper in a preceding paper unit and a first sheet of paper in a subsequent paper unit, such that the paper unit spacing differs between a first mode, in which both the punching process and the binding process are performed, and a second mode, in which only the punching process is performed.

17. The bookbinding method according to claim 16, wherein the first mode and the second mode are selected based on command information from an image forming device.

18. The bookbinding method according to claim 17, wherein the command information includes printing information from a personal computer connected to the image forming device.

19. The bookbinding method according to claim 16, wherein the changing includes any one of
changing a setting of a timing for paper feeding,
selecting another conveying path having a different conveying path length, and changing a conveying path length for a sheet of paper,
providing a buffer member on a conveying path of a sheet of paper, and changing a conveyance timing from the buffer member, and
changing a conveyance speed of a sheet of paper on a conveyance path of the sheet of paper is performed.

20. A computer program product including a computer-readable recording medium and computer program code stored on the computer-readable recording medium which when executed on a computer causes the computer to execute on a bookbinding device that includes a punching unit that performs a punching process on a sheet of paper or a stack of paper, the punching process including making a hole in the sheet of paper or the stack of paper; and a binding unit that performs a binding process on the sheet of paper or a stack of paper, the binding process including inserting a ring member in the hole:
judging a current processing mode, the current processing mode being any one of a first mode, in which both the punching process and the binding process are performed, and a second mode, in which only the punching process is performed; and
setting a paper unit spacing, which is an interval between a last sheet of paper in a preceding paper unit and a first sheet of paper in a subsequent paper unit, corresponding to the current processing mode, a paper unit spacing for the first mode being longer than a paper unit spacing for the second mode.
